(19) United States
(12) Patent Application Publication
(10) Pub. No.: US 2022/0210290 A1
(43) Pub. Date: Jun. 30, 2022

(54) DOCUMENT MANAGEMENT OF IMAGE FORMING DEVICE

(71) Applicant: Hewlett-Packard Development Company, L.P., Spring, TX (US)

(72) Inventors: Hyungsoo OHK, Seongnam-si (KR); Yuna KIM, Seongnam-si (KR); Hojae JO, Seongnam-si (KR)

(21) Appl. No.: 17/605,968

(22) PCT Filed: Jun. 8, 2020
(86) PCT No.: PCT/US2020/036615

§ 371 Date: Oct. 22, 2021

(30) Foreign Application Priority Data
Nov. 28, 2019 (KR) 10-2019-0155593

(51) Int. Cl. H04N 1/32; G06V 30/226; G06V 30/418; G06F 16/93

(52) U.S. Cl. CPC H04N 1/3247; G06V 30/226; H04N 2201/3243; G06F 16/93; H04N 2201/3245; G06V 30/418

(57) ABSTRACT

An example image forming device includes an image input unit to receive a plurality of original documents, and a processor to extract handwriting from the respective original documents to generate a printed layer and a handwritten layer for each of the respective original documents, and to reconfigure the printed layers and a plurality of handwritten layers sharing the printed layers as respective files.

### BACKGROUND OF THE INVENTION

When each of a plurality of reviewers writes their review on a respective original file, a plurality of documents may be generated by writing the review content on the respective original file, such as a case in which each of a plurality of writers writes their review content to a respective form.

Currently, a document management system individually manages the respective documents generated as described above. For example, when there are n document reviewers or document writers, the document management system stores n scan documents and manages the same.

### BRIEF DESCRIPTION OF THE DRAWINGS

Various examples will be described below by referring to the following figures.

FIG. 1 shows an image forming device according to an example.

FIG. 2 shows a method for reconfiguring a document according to an example.

FIG. 3 shows a document management method according to an example.

FIG. 4 and FIG. 5 show an operation of a document reconfiguring unit according to an example.

FIG. 6 shows a cloud server according to an example.

FIG. 7 shows a document call and a response method to a call according to an example.

FIG. 8 shows a document generating method according to a file call reconfigured by a combination method according to an example.

FIG. 9 shows a document generating method according to a file call reconfigured by a separation method according to an example.

FIG. 10 shows a document call and a response method to a call according to an example.

FIG. 11 shows a document call and a response method to a call according to an example.

FIG. 12 shows a schematic diagram of a computing device according to an example.

### DETAILED DESCRIPTION OF EXAMPLES

The present invention will be described more fully hereinafter with reference to the accompanying drawings, in which examples of the invention are shown. As those skilled in the art will realize, the described examples may be modified in various different ways, all without departing from the spirit or scope of the present invention. Accordingly, the drawings and description are to be regarded as illustrative in nature and not restrictive. Like reference numerals designate like elements throughout the specification.

Unless explicitly described to the contrary, the word “comprise” and variations such as “comprises” or “comprising” will be understood to imply the inclusion of stated elements but not the exclusion of any other elements.

In addition, the terms “-er”, “-or”, and “module” described in the specification refer to units for processing at least one function and operation and can be implemented by hardware components, software components, or combinations thereof.

A server and a device hereinafter described may each be configured with at least one processor, a memory, and a communication apparatus as its hardware, and a program performed in combination with hardware may be stored in a designated location. The hardware has a configuration for performing a method according to examples of the present invention. The program includes instructions having realized an operation method according to examples of the present invention described with reference to drawings, and examples of the present invention may be performed in combination with hardware such as a processor or a memory.

In the described examples, “transmission or provision” may include indirect transmission or provision via another device or by use of a bypass in addition to direct transmission or provision.

In the described examples, an expression recited in the singular may be construed as singular or plural unless the expression “one”, “single”, etc. is used.

In the described examples, regardless of the drawing, the same reference numbers refer to the same constituent elements, and “and/or” includes all combinations of each and at least one of the constituent elements mentioned.

In the flowcharts described with reference to the drawings in this specification, the operation order may be changed, various operations may be merged, certain operations may be divided, and certain operations may not be performed.

When a plurality of hardcopies derived from comments, reviews, etc. respectively written by a plurality of writers on a plurality of similar original hardcopies exists, for example, when a plurality of hardcopies of comments written on a same original text by a plurality of reviewers or writers exists, a number of scan files corresponding to the number of reviewers or writers is generated when each of the plurality of hardcopies is scanned. To indicate a correspondence or relationship between the plurality of scan files generated in this way, a rule on file names may be set when the plurality of hardcopies are scanned, or a user may be allowed to reset a file name of the scanned documents after they are scanned. However, this is an inefficient manner of management of scanned files, and it may cause deterioration of storage efficiency when capacity for storing a plurality of scan files is considered.

To address the above-noted drawbacks, a printed layer and a handwritten layer may be distinguished on a plurality of respective documents, at least one handwritten layer sharing a random printed layer from among printed layers on a plurality of documents and the corresponding random printed layer may be grouped together, the grouped printed layer and at least one handwritten layer may be reconfigured as a single file, or the grouped printed layer and at least one handwritten layer may be reconfigured as individual files.

An example will be described with reference to accompanying drawings.

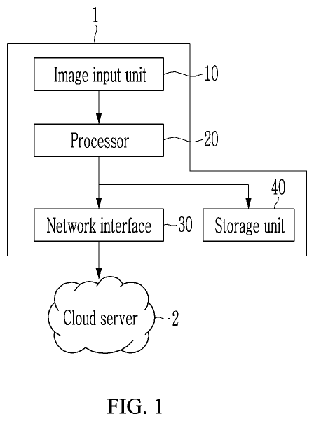

FIG. 1 shows an image forming device according to an example.

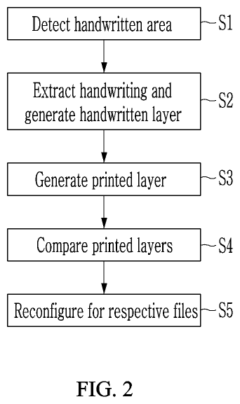

FIG. 2 shows a method for reconfiguring a document according to an example.

Referring to FIG. 1, an image forming device 1 includes an image input unit 10, a processor 20, a network interface 30, and a storage unit 40.

The image input unit 10 receives a plurality of original documents generated by scanning a plurality of hardcopies. In an example, the image input unit 10 may generate the plurality of original documents generated by scanning the plurality of hardcopies and may receive the same by providing a scan function. In an example, the image input unit 10 may receive a plurality of scanned original documents. The original documents may be configured with image data generated by scanning.

The processor 20 extracts handwriting from the plurality of original documents and generates a plurality of printed layers and a plurality of handwritten layers from the respective plurality of original documents. The processor 20 reconfigures the plurality of handwritten layers sharing the same printed layer for respective files according to a result of comparing the printed layers.

Referring to FIG. 2, the processor 20 detects handwriting areas from each of a plurality of original documents in operation S1. The processor 20 extracts handwriting from a detected handwriting area and generates a handwritten layer in operation S2. The processor 20 generates a printed layer from which the handwritten layer is removed from the original document in operation S3. The handwritten layer and the printed layer may be configured with image data.

An example method for detecting and extracting the handwriting area may be realized by various methods known to a person skilled in the art, and various methods using deep learning are under development. A conventional known method is a handwriting area detecting method for distinguishing handwriting and a printed document by using features of the document (or text). This method may classify the handwriting from the printed document according to the features such as edge intensity and edge directivity of characters or positions of the characters.

The processor 20 compares printed layers of a plurality of original documents in operation S4. In operation S5, the processor 20 may connect or correlate a plurality of handwritten layers sharing the same printed layer to the same printed layer based on the comparison of the printed layers, may store the correlated plurality of handwritten layers sharing the same printed layer, and may reconfigure the correlated plurality of handwritten layers sharing the same printed layer for respective files.

For example, the printed layer and the handwritten layers of a plurality of original documents sharing the same printed layer may be reconfigured to be a single file. In another example, the printed layer and the handwritten layers of a plurality of original documents sharing the same printed layer may be reconfigured to be individual files.

As described above, the processor 20 receives a plurality of original documents from the image input unit 10 and extracts handwriting from a plurality of original documents (DC1-DC4) to generate printed layers (PL1-PL4) and handwritten layers (HL1-HL4) from the original documents. The processor 20 reconfigures the printed layers (PL1-PL4) and at least one handwritten layer (HL1-HL3, and HL4) sharing the respective printed layers for respective files.

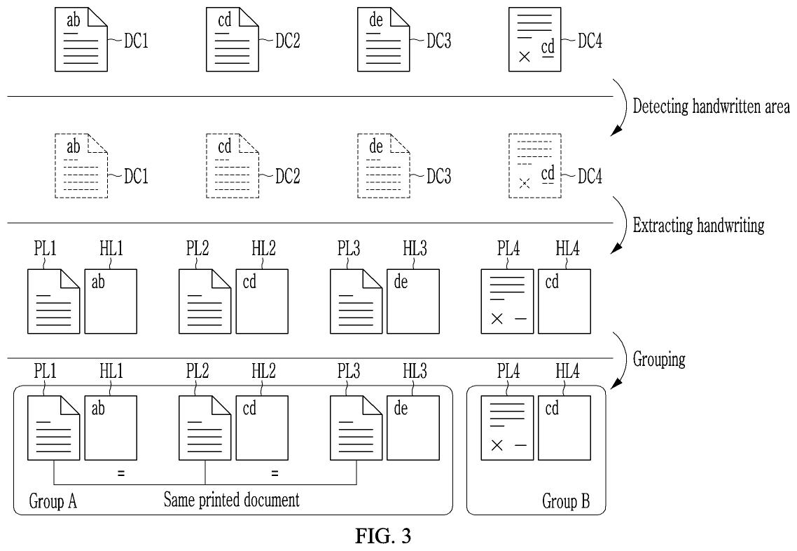

FIG. 3 shows a document management method according to an example.

Referring to FIG. 3, four original documents (DC1, DC2, DC3, and DC4) are illustrated to describe a document management method according to an example. The number of original documents (e.g., DC1-DC4) is not limited to the example illustrated in FIG. 3. Further, FIG. 3 illustrates an example operation for distinguishing and reconfiguring the printed layer and the handwritten layer to briefly show the original document, which does not limit the present example.

Regarding the four original documents (DC1-DC4), a handwriting area detector of the processor 20 detects a handwriting area. For example, handwriting ‘ab’ is detected from the original document DC1, handwriting ‘cd’ is detected from the original document DC2, handwriting ‘de’ is detected from the original document DC3, and handwriting ‘cd’ is detected from the original document DC4.

The processor 20 extracts the detected handwriting areas from the respective original documents (DC1-DC4) to generate handwritten layers (HL1, HL2, HL3, and HL4) and to generate printed layers (PL1, PL2, PL3, and PL4) generated by removing the handwriting from the original documents (DC1-DC4).

The processor 20 compares the printed layers (PL1-PL4) to find an identical printed layer, and groups the handwritten layers sharing the same printed layer with the same printed layer. For example, the processor 20 may extract features of the respective printed layers and may find the same printed layer by a comparison of similarities between the extracted features. However, this is only an example and the method for finding the same printed layer is not limited thereto. Rather, various known methods are also applicable.

As shown in FIG. 3, the printed layers (PL1-PL3) are the same printed layer, and the handwritten layers (HL1-HL3) sharing the same printed layer and the same printed layers (PL1-PL3) are divided as group A. The printed layer PL4 is different from the printed layers (PL1-PL3), and the printed layer PL4 and the handwritten layer HL4 corresponding to the printed layer PL4 are divided as group B.

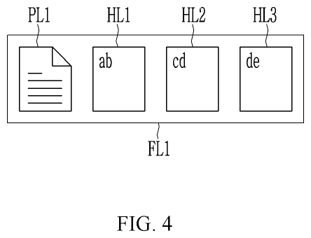

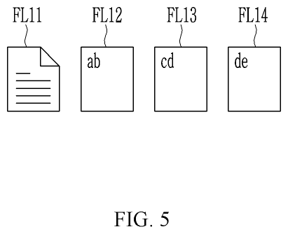

FIG. 4 and FIG. 5 show an operation of a document reconfiguring unit according to an example.

Referring to FIG. 4, for the group A of FIG. 3, the processor 20 may reconfigure the printed layer PL1 from among the printed layers (PL1-PL3) and the handwritten layers (HL1-HL3) to be a single file FL1. The printed layer PL1 from among the same printed layers (PL1-PL3) is included in the file FL1, and it may be changed to one of the other printed layers PL2 and PL3. For ease of description, the method shown in FIG. 4 will be referred to as a combination method.

Referring to FIG. 5, for the group A, the processor 20 may reconfigure the printed layer PL1 which is one of the printed layers (PL1-PL3) and the handwritten layers (HL1-HL3) as files (FL11, FL12, FL13, and FL14). The printed layer PL1 that is one of the same printed layers (PL1-PL3) is configured to be the file FL11. However, either one of the other printed layers PL2 and PL3 may also be configured to be the file FL11. For ease of description, the example method shown in FIG. 5 will be referred to as a separation method.

The examples described with reference to FIG. 4 and FIG. 5 may be applicable to the group B in FIG. 3. That is, the processor 20 may reconfigure the printed layer PL4 and the handwritten layer HL4 into a single file. In another example, the document reconfiguring unit 24 may reconfigure the printed layer PL4 and the handwritten layer HL4 into respective files, for the group B.

The combination method shown in FIG. 4 represents a method for combining a plurality of original documents generated based on the same printed document into one file (e.g., a PDF file), and it may be useful for many reviewers to add opinions, corrections, comments, etc. to the same printed document and manage a plurality of generated original documents.

The separation method shown in FIG. 5 writes link information to the respective files of a plurality of handwritten layers generated based on the same printed document to generate the same printed document and a plurality of handwritten layers as individual files and manage them. The link information may be written to a header of each file. For example, information on the file FL11 may be written to the headers of the files (FL12-FL14). In another example, the processor 20 may generate a table on which link information between files is written. For example, relationships between the files (FL12-FL14) and the file FL11 storing the printed layer in common to the files (FL12-FL14) may be made into a table. The separation method shown in FIG. 5 may be a method that is appropriate in managing applications for admission generated by writing multiple persons to the printed document with the same form.

The processor 20 may transmit files to at least one of the storage unit 40 and the network interface 30, and it may transmit a table on which link information between files is written, together with the files.

When receiving the files from the processor 20, the storage unit 40 stores the files, and it may store the table on which link information between files is written together with the files.

When receiving the files from the processor 20, the network interface 30 may transmit the files to a cloud server 2 connected to the image forming device 1 through a network and may update the same. In this instance, the processor 20 may update the table on which link information between files is written together with the files.

It is been described that the image forming device 1 reconfigures a plurality of original documents. However, examples are not limited thereto. In an example, the cloud server 2 may reconfigure a plurality of original documents.

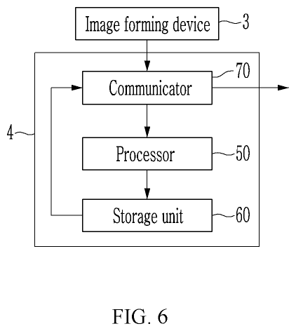

FIG. 6 shows a cloud server according to an example.

FIG. 6 illustrates certain elements of the cloud server so as to describe an example. However, it is to be understood that the cloud server may include additional elements.

Referring to FIG. 6, a cloud server 4 includes a processor 50, a storage unit 60, and a communicator 70.

The communicator 70 receives a plurality of original documents generated by scanning a plurality of hardcopies from an image forming device 3. The image forming device 3 generates the plurality of original documents by scanning a plurality of hardcopies and transmits the plurality of original documents to the cloud server 4. The communicator 70 receives the plurality of original documents and transmits the same to the processor 50. Each original document may be configured with the image data generated through scanning.

The processor 50 extracts handwriting from the plurality of original documents to generate a printed layer and a handwritten layer from each of the original documents. The processor 50 reconfigures the printed layers and at least one handwritten layer sharing the respective printed layers for respective files. An example operation of the processor 50 corresponds to the operation of the processor 20, so a redundant description thereof will not be provided.

The storage unit 60 receives the reconfigured file from the processor 50 and stores the same.

When a document call is provided from the outside, the communicator 70 receives the document call, reads files of the document called by the storage unit 60, and transmits the read files to an external terminal in response to the document call. For example, the external terminals may be various terminals such as the image forming device 3 or a user terminal.

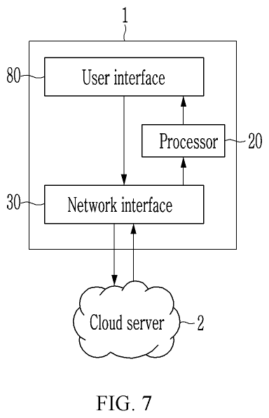

FIG. 7 shows a document call and a response method to a call according to an example.

FIG. 7 will describe an example in which a document stored in the cloud server 2 is called through the image forming device 1.

Referring to FIG. 7, the image forming device 1 further includes a user interface 80, and the user selects a desired file through the user interface 80. The user interface 80 may receive information on a plurality of files stored in the cloud server 2 through the network interface 30, and may provide the same to the user.

The file selected by the user interface 80 is transmitted to the cloud server 2 through the network interface 30, and the cloud server 2 detects the selected document file, or detects the selected document file and the file relating to the selected document file, and transmits the same to the network interface 30. The selected document file or the selected document file and the document file relating to the selected document file are transmitted to the processor 20 through the network interface 30.

The processor 20 generates a document based on the selected document file or the selected document file and the document file relating to the selected document file, and provides the generated document to the user interface 80. The user interface 80 displays the document.

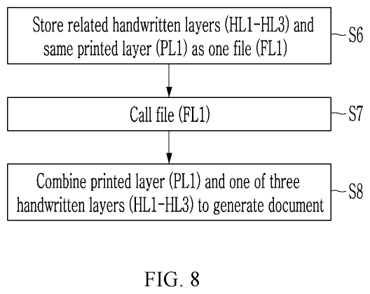

FIG. 8 shows a document generating method according to a file call reconfigured by a combination method according to an example.

Referring to FIG. 8, the processor 20 may store a plurality of related handwritten layers (HL1-HL3) and the same printed layer PL1 as a single file FL1 according to the combination method shown in FIG. 4 in operation S6.

The user may select the file FL1 shown in FIG. 4 through the user interface 80 and may call the file FL1 in operation S7. The cloud server 2 detects the file FL1, and the file FL1 is transmitted to the processor 20 through the network interface 30.

The processor 20 combines the printed layer PL1 included in the file FL1 and one of the three handwritten layers (HL1-HL3) to generate a document in operation S8.

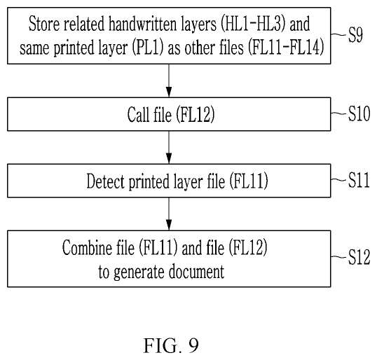

FIG. 9 shows a document generating method according to a file call reconfigured by a separation method according to an example.

Referring to FIG. 9, the processor 20 may store a plurality of related handwritten layers (HL1-HL3) and the same printed layer PL1 as individual files (FL11-FL14) according to the separation method shown in FIG. 5 in operation S9.

The user may select the file FL12 shown in FIG. 5 through the user interface 80 and may call the file FL12 in operation S10. The cloud server 2 detects the related file FL11 based on the file FL12 and the link information in operation S11.

The cloud server 2 transmits the file FL11 and the file FL12 to the processor 20 through the network interface 30. The processor 20 combines the file FL11 and the file FL12 to generate a document in operation S12.

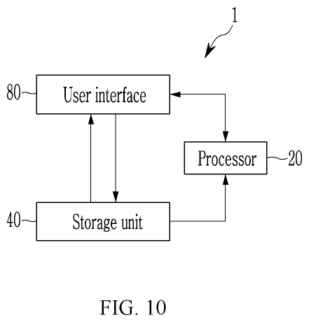

FIG. 10 shows a document call and a response method to a call according to an example.

In the example of FIG. 10, the storage unit 40 of the image forming device 1 receives the file on the reconfigured document from the processor 20 and stores the same, and the processor 20 calls the document from the storage unit 40.

Referring to FIG. 10, a user selects a desired file through the user interface 80. The user interface 80 may read information on a plurality of stored files from the storage unit 40 and may provide the information to the user.

The file selected by the user interface 80 is transmitted to the processor 20, and the processor 20 reads the selected file or the selected document file and the document file relating to the selected document file from the storage unit 40. The processor 20 generates a document based on the document file or the selected document file and the document file relating to the selected document file, and provides the generated document to the user interface 80. The user interface 80 displays the document.

For example, the user may select the file FL1 shown in FIG. 4. The processor 20 reads the file FL1 from the storage unit 40 and combines the printed layer PL1 included in the file FL1 and the three handwritten layers (HL1-HL3) to generate a document.

In another example, the user may select the file FL12 shown in FIG. 5. The processor 20 detects the related file FL11 based on the file FL12 and link information from the storage unit 40 and reads the file FL11 and the file FL12. The processor 20 combines the file FL11 and the file FL12 to generate a document.

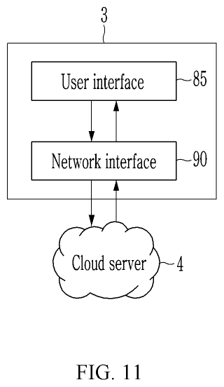

FIG. 11 shows a document call and a response method to a call according to an example.

In FIG. 11, a response to a document call by the cloud server 4 according to an example described with reference to FIG. 7 will be described.

Referring to FIG. 11, the image forming device 3 may include a user interface 85 and a network interface 90. The network interface 90 may be connected to the cloud server 4 through a network, and the user interface 85 may be connected to the network interface 90 through various wired or wireless communication methods.

The user selects a desired file through the user interface 85. The user interface 85 may receive information on a plurality of files stored in the cloud server 4 through the network interface 90 and may provide the information on the plurality of files to the user.

The file selected by the user interface 85 is transmitted to the cloud server 4 through the network interface 90. The cloud server 4 detects the selected file or the selected document file and the document file relating to the selected document file from the storage unit 60, generates a document based on the detected document file or the detected document file and the document file relating to the selected document file, and transmits the generated document to the network interface 90.

As an example, the processor 50 of the cloud server 4 generates a document based on the detected document file or the detected document file and the document file relating to the selected document file, and provides the generated document to the communicator 70. The communicator 70 transmits the generated document to the user interface 85 through the network interface 90, and the user interface 85 displays the document.

For example, the user may select the file FL1 shown in FIG. 4. The cloud server 4 detects the file FL1, and the processor 50 combines the printed layer PL1 included in the file FL1 and the three handwritten layers (HL1-HL3) to generate a document.

In another example, the user may select the file FL12 shown in FIG. 5. The cloud server 4 detects the file FL11 based on the file FL12 and link information, and the processor 50 combines the file FL11 and the file FL12 to generate a document.

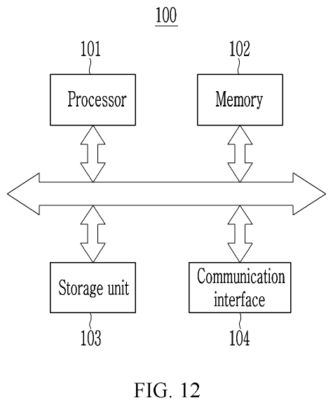

FIG. 12 shows a schematic diagram of a computing device according to an example.

A processor has been described to be applied to the image forming device 1 and the cloud server 4. However, examples are not limited thereto, and the processor is applicable to various computing devices.

Referring to FIG. 12, a computing device 100 may include at least one processor 101, a memory 102, a storage unit 103, and a communication interface 104 as hardware, and they may be connected through a bus. In addition, the computing device 100 may include an input device and an output device as hardware. Various kinds of software in addition to an operating system for driving a program may be included in the computing device 100.

The processor 101 represents a device for controlling an operation of the computing device 100. The processor 101 may be any of various forms of processors for processing instructions included in a program, for example, it may be a central processing unit (CPU), a microprocessor unit (MPU), a microcontroller unit (MCU), or a graphics processing unit (GPU). The processor 101 may perform a program including instructions described to perform an operation according to examples.

The memory 102 may load a corresponding program so that the instructions described to perform the operation according to examples may be processed by the processor 101. The memory 102 may exemplarily be a read only memory (ROM) or a random access memory (RAM). The storage unit 103 may store various data and programs required to perform the operation according to examples. The communication interface 104 may be a wire/wireless communication module.

The processor 101 may perform the instructions of the program loaded to the memory 102, and the program may include instructions to extract handwriting from a plurality of original documents and to generate a printed layer and a handwritten layer from the respective original documents, and to reconfigure the printed layers and at least one handwritten layer sharing the respective printed layers for respective files.

The above-described examples may efficiently reconfigure a document by grouping original documents based on the same original document and managing the files in management of various documents in which additional information is written on the same original document. Efficiency of a file storage space may be improved by combining many documents derived from the same original document into one. Further, efficiency of document management is also improved by reducing the number of documents to be managed and stored.

A manager may manage a plurality of original documents with one file by combining a plurality of original documents derived from the same original document into one. Further, it is possible to efficiently understand the content of the document by opening a plurality of original documents derived from the same original document as a single document.

While examples have been described above, it is to be understood that the invention is not limited to the disclosed example, but, on the contrary, is intended to cover various modifications and equivalent arrangements included within the spirit and scope of the appended claims.

What is claimed is:

1. An image forming device comprising:
an image input unit to receive a plurality of original documents; and
a processor to:
extract handwriting from the respective original documents to generate a printed layer and a handwritten layer for each of the respective original documents, and
reconfigure the printed layers and a plurality of handwritten layers sharing the printed layers as respective files.

2. The image forming device of claim 1, wherein the processor is further to:
detect a handwriting area from each of the respective original documents,
extract handwriting from the detected handwriting area to generate the handwritten layer for each of the respective original documents, and
generate a plurality of printed layers from which the handwritten layer is removed.

3. The image forming device of claim 2, wherein the processor is further to:
compare the plurality of printed layers,
connect the handwritten layers sharing a same printed layer to the same printed layer, and
store the connected handwritten layers sharing the same printed layer and the same printed layer.

4. The image forming device of claim 3, wherein the processor is further to:
store the connected handwritten layers sharing the same printed layer and the same printed layer as a single file, or
store the connected handwritten layers sharing the same printed layer and the same printed layer as individual files.

5. The image forming device of claim 4,
wherein the connected handwritten layers sharing the same printed layer and the same printed layer are stored as a single file by the processor, and
wherein, when the single file is called, the processor is further to generate a document by combining one of the connected handwritten layers and the same printed layer.

6. The image forming device of claim 4,
wherein the connected handwritten layers sharing the same printed layer and the same printed layer are stored as individual files by the processor, and
when one of the individual files is called, the processor is further to generate a document by combining the called file from among the files of the handwritten layers and the file of the same printed layer.

7. A server comprising:
a communicator to receive a plurality of original documents through a network; and
a processor to:
extract handwriting from the respective original documents to generate a printed layer and a handwritten layer for each of the respective original documents, and
reconfigure the respective printed layers and a plurality of handwritten layers sharing the printed layers as respective files.

8. The server of claim 7, wherein the processor is further to:
detect a handwriting area from each of the respective original documents,
extract handwriting from the detected handwriting area to generate the handwritten layer for each of the respective original documents, and
generate a plurality of printed layers from which the handwritten layer is removed.

9. The server of claim 8, wherein the processor is further to:
compare the plurality of printed layers,
connect the handwritten layers sharing a same printed layer to the same printed layer, and
store the connected handwritten layers sharing the same printed layer and the same printed layer.

10. The server of claim 9, wherein the processor is further to:
store the connected handwritten layers sharing the same printed layer and the same printed layer as a single file, or
store the connected handwritten layers sharing the same printed layer and the same printed layer as individual files.

11. The server of claim 10,
wherein the connected handwritten layers sharing the same printed layer and the same printed layer are stored as a single file by the processor, and
wherein, when the single file is called, the processor is further to generate a document by combining the connected handwritten layers and the same printed layer.

12. The server of claim 10,
wherein the connected handwritten layers sharing the same printed layer and the same printed layer are stored as individual files by the processor, and
wherein, when one of the individual files is called, the processor is further to generate a document by combining the called file from among the files of the handwritten layers and the file of the same printed layer.

13. A computing device comprising:
a memory; and
at least one processor to perform instructions of a program loaded to the memory,
wherein the program comprises instructions to:
extract handwriting from each of a plurality of original documents to generate a printed layer and a handwritten layer for each of the respective original documents; and
reconfigure the printed layers and a plurality of handwritten layers sharing the respective printed layers as respective files.

14. The computing device of claim 13, wherein the reconfiguring of the respective files comprises:
connecting a plurality of handwritten layers sharing a same printed layer to the same printed layer; and
storing the connected handwritten layers sharing the same printed layer and the same printed layer as at least one file.

15. The computing device of claim 14, wherein the storing as at least one file comprises:
storing the connected handwritten layers sharing the same printed layer and the same printed layer as a single file; or
storing the connected handwritten layers sharing the same printed layer and the same printed layer as individual files.
